(19) United States
(12) Patent Application Publication
(10) Pub. No.: US 2011/0073428 A1
(43) Pub. Date: Mar. 31, 2011

(54) NON-PLANAR PRESSURIZED OIL ROUTING

(75) Inventor: Magnus ABERG, Trollhattan (SE)

(73) Assignee: GM GLOBAL TECHNOLOGY OPERATIONS, INC., Detroit, MI (US)

(21) Appl. No.: 12/889,333

(22) Filed: Sep. 23, 2010

(30) Foreign Application Priority Data
Sep. 28, 2009 (GB) 0916972.3

(51) Int. Cl. F16D 25/10

(52) U.S. Cl. 192/48.616; 192/48.601

(57) ABSTRACT

A casing is provided for a dual clutch actuation device of a transmission. The casing includes, but is not limited to an internal inner liquid supply passage for connecting to the inner chamber and an internal outer liquid supply passage for connecting to the outer chamber. The inner liquid supply passage includes, but is not limited to a first inner straight section and a second inner straight section for connecting to the inner chamber. Similarly, the outer liquid supply passage includes, but is not limited to a first outer straight section and a second outer straight section for connecting to the outer chamber. In particular, the inner liquid supply passage is provided essentially adjacent to the outer liquid supply passage. The first outer straight section is at an incline relative to the first inner straight section.

### CROSS-REFERENCE TO RELATED APPLICATION

This application claims priority to British Patent Application No. 0916972.3, filed Sep. 28, 2009, which is incorporated herein by reference in its entirety.

### TECHNICAL FIELD

This application relates to a clutch actuation device for clutches of a Dual Clutch Transmission. In particular, it relates to a clutch casing with pressurized oil routes for the clutch actuation device.

### BACKGROUND

A Double Clutch Transmission comprises two input shafts that are connected to and are actuated by two clutches separately. The Double Clutch Transmission is also known as Dual Clutch Transmission. The two clutches are often combined into a single device that permits actuating any of the two clutches at a time. The two clutches are connected to two input shafts of the DCT separately for providing driving torques.

At least one object of this application is to provide an improved clutch actuation device that is cost efficient. In addition, other objects, desirable features, and characteristics will become apparent from the subsequent summary and detailed description, and the appended claims, taken in conjunction with the accompanying drawings and this background.

### SUMMARY

The clutch selectively transmits turning motion of an engine to the transmission whilst the transmission transmits the received turning motion to wheels. The engine uses fuel to produce turning motion or mechanical power. The wheels are attached usually to a vehicle that is used in transportation.

One of the main thoughts of the application is to provide a device casing with routes for pressurized liquid, such as lubricating oil, is needed to support concentric slave cylinders (CSC) that actuates a clutch release system for a dual clutch transmission. The dual clutch transmission can provide a manual or an automatic transmission.

The routes do not intersect or communicate so that the concentric slave cylinders can work independently. Put different, the routes does not allow working liquid or fluid within each route to mix with working liquid in another route. The device casing supports a tight packaging that has space for the clutch release system and space for retention bolts of input shaft bearing. In practice, the working liquid can include gas. The bolts are used for fastening components together.

The application provides a device casing or housing for a dual clutch actuation device of an engine transmission. The device casing encloses the clutch actuation device, which is fixed usually to a clutch casing. The device casing encloses parts of the concentric slave cylinders whilst the clutch casing encloses clutches and the clutch actuation device.

The dual clutch actuation device includes concentric slave cylinders that comprise an inner chamber and an outer chamber, wherein the outer chamber surrounds either a portion of the inner chamber or the entire inner chamber. The inner chamber and the outer chamber share essentially the same axis. The outer chamber usually has an annular shape. It should be understood that the term “annular”, as used here, refers essentially to a band with an essentially circular shape. The inner chamber can have the annular shape or a cylindrical shape. The inner chamber is used for receiving a working liquid under pressure for actuating a first clutch disc whilst the outer chamber is used for receiving the working liquid under pressure for actuating a second clutch disc.

Specifically, the outer chamber surrounds either a portion of the inner chamber or the entire inner chamber. The working liquid can include lubricating oil. The pressure of the liquid is used to actuate the first clutch disc or the second clutch disc. The first clutch disc and the second clutch disc selectively couple or connect an engine to the Dual Clutch Transmission.

The device casing includes an internal inner liquid supply passage and an internal outer liquid supply passage. The inner liquid supply passage and the outer liquid supply passage are placed within walls of the device casing or the clutch casing. In other words, they are positioned internal to the device casing or the clutch casing. This reduces space requirement of the device casing as the clutch casing.

The internal inner liquid supply passage is intended for connecting to the inner chamber. Put differently, the inner liquid supply passage provides a path so that the working liquid can be introduced to the inner chamber. The inner liquid supply passage comprises a first inner straight section and a second inner straight section, wherein the second inner straight section is intended for connecting to the inner chamber. The first inner straight section and the second inner straight section are connected so that a liquid the first inner straight section can flow to the second inner straight section.

In a similar manner, the internal outer liquid supply passage is used for connecting to the outer chamber. The outer liquid supply passage includes a first outer straight section and a second outer straight section. The second outer straight section is intended for connecting to the outer chamber. The first outer straight section and the second outer straight section are connected so that a liquid in the first outer straight section can flows into the second outer straight section.

The provision here of two liquid supply passages within the device casing instead of one liquid supply passage has the benefit of enabling the concentric slave cylinders to function correctly. The outer chamber can function independent of the inner chamber. As an example, the outer chamber can receive a clutch actuation oil pressure whilst the inner chamber can receive a lower working oil pressure.

Further, the internal inner liquid supply passage can be provided essentially or mostly adjacent to the internal outer liquid supply passage so that the internal inner liquid supply passage does not intersect with the internal outer liquid supply passage. An intersection between the liquid supply passages would cause the inner chamber and the outer chamber to be dependent on each other and thus not work properly. This adjacent placement has the advantages of easier routing design and of easier production of the device casing.

The first inner straight section, the second inner straight section, the first outer straight section, and the second outer straight section are formed usually by machining or drilling. The internal inner liquid supply passage and the internal outer liquid supply passage can be provided or be positioned at different levels or heights. The different levels provide a means for the internal inner liquid supply passage and the internal outer liquid supply passage to avoid intersecting with each other. Other means for providing the said avoidance is also possible. The first outer straight section can have an incline or a slight angle relative to the first inner straight section. The incline facilitates passage routing for certain device casing structures such that the respective section does not intersect with each other.

The second inner straight section and the second outer straight section can be substantially perpendicular to an axis of the concentric slave cylinders. The perpendicular connection can allow for easier production of the second inner straight section with the inner chamber and easier production of the second outer straight section with the outer chamber. A section or channel seal can block one end of the second inner straight section so that the working liquid does not leak out of the device casing. The first inner straight section can be substantially perpendicular to the second inner straight section for easier production of these said sections. The first outer straight section can be connected to the second outer straight section passage via a connecting straight section. The additional connecting straight section allows easier bypass of the internal inner liquid supply passage. A section or channel seal can block one end of the connecting straight section to prevent leak of working liquid from the device casing. The first outer straight section can be substantially perpendicular to the connecting straight section. The second outer straight section can be substantially perpendicular to the connecting straight section. These said perpendicular connection allows easier alignment for connecting during production of the said connection.

The application provides a clutch actuation device for dual clutches of a Dual Clutch Transmission. The dual clutches act as coupling devices between a combustion engine and the Dual Clutch Transmission. The Dual Clutch Transmission comprises gearwheels with teeth around its outer edges for controlling mechanical power from the combustion engine to wheels of a vehicle and for providing speed-changing gears for a user of the vehicle.

The clutch actuation device comprises a cylinder assembly that is fixed to the above-mentioned device casing. In particular, the device casing comprises an internal inner liquid supply passage and an internal outer liquid supply passage. The internal inner liquid supply passage and the internal outer liquid supply passage are placed within the device casing.

The cylinder assembly includes an inner chamber and an inner piston that is slidably disposed in the inner chamber as well as an outer chamber and an outer piston that is slidably disposed in the outer chamber. The inner chamber is used for receiving liquid under pressure via the inner liquid supply passage. The inner chamber comprises an inner inlet. Likewise, the outer chamber is used for receiving liquid under pressure via the outer liquid supply passage. The outer chamber comprises an outer inlet. Either a portion of the inner chamber or the entire of the inner chamber is surrounded by the outer chamber. The inner piston is used for actuating a first clutch disc whilst the outer piston is intended for actuating a second clutch disc.

The clutch actuation device can further comprise an inner piston seal that is fixed to the inner piston and an outer piston seal that is fixed to the outer piston. The inner piston seal and the outer piston seal prevent the liquid within from leaking or keep the liquid within the respective chamber. The clutch actuation device can include a hydraulic circuit that comprises a liquid source, a pump, and an operating valve. The pump is connected to the liquid source and to the operating valve. In particular, the liquid source is positioned usually in a lower part of the Dual Clutch Transmission. The liquid source stores or receives liquid for later use by another component. In application, the liquid source can include a sump. The sump is used for containing liquids in a vehicle. The pump supplies the liquid under pressure from the liquid source to the outer annular chamber via the operating valve and to the inner annular chamber via the operating valve.

The operating valve regulates the flow of liquid. The regulation may stop the flow or restrict the flow such that the pressure of the liquid changes. Operationally, the liquid flows through the operating valve selectively engage one of the outer piston and the inner piston as to release the other. The outer piston is disposed in the outer chamber whilst the inner piston is disposed in the inner chamber. Further, the operating valve controls the pressure of the liquid to engage selectively one piston and to release of the other piston. The selected piston can refer to the outer annular piston or to the inner annular piston. The selected chamber receives a clutch actuation pressure for actuating the corresponding selected piston and clutch.

The clutch actuation device can also include a pressure relief valve and a conduit means. The conduit means provides liquid passageway and it is connected to a discharge side of the pressure relief valve and to the liquid source. The relief valve maintains a minimum fluid pressure level. The relief valve is arranged with the operating valve such that a predetermined clutch actuation pressure is established in the chamber of the engaged piston whilst a relatively lower pressure is established in the chamber of the unengaged or the disengaged piston. The lower pressure is in reference to the clutch actuation pressure. The lower pressure allows the chamber of the unengaged piston to be filled or be occupied with liquid.

The application provides a clutch actuation device for a Dual Clutch Transmission. The clutch actuation device comprises a cylinder assembly that includes a first hydraulic motor and a second hydraulic motor. The first hydraulic motor is used for actuating a first clutch of the Dual Clutch Transmission whilst the second hydraulic motor is used for actuating a second clutch of the Dual Clutch Transmission. In particular, the first hydraulic motor and the second hydraulic motor are arranged such that either a part of the first hydraulic motor or the entire first hydraulic motor is enclosed by the second hydraulic motor. In addition, the cylinder assembly is fixed to the above-mentioned device casing. The small size of the device casing allows the entire clutch actuation device also to have a small size. In some implementation, the first hydraulic motor comprises an inner liquid chamber, wherein an inner piston is disposed in the inner liquid chamber. In a similar manner, the second hydraulic motor also comprises an outer liquid chamber and an outer piston is disposed in the outer liquid chamber. Either a part of the inner chamber or the entire inner chamber is enclosed by the outer chamber.

The application provides a Dual clutch Transmission for an engine, such as combustion engine. The Dual clutch Transmission comprises a first clutch disc that is connected to an inner input shaft and one or more input gearwheels that are provided on the inner input shaft. The gearwheels have teeth around its outer edges for controlling mechanical power from a combustion engine to one or more wheels of a vehicle. The first clutch disc is used for selectively connecting the inner input shaft to the combustion engine. The input gearwheels are connected or engaged to output gearwheels that are placed on an output shaft.

Furthermore, the Dual clutch Transmission includes a second clutch disc that is connected to an outer input shaft and one or more input gearwheels that are provided on the outer input shaft. The second clutch disc is used for selectively connecting the outer input shaft to the combustion engine. The inner input shaft and the outer input shaft are arranged such that either a portion of or the entire the inner input shaft is surrounded by the outer input shaft. The above clutch actuation device selectively actuates the first clutch disc and the second clutch disc to engage a combustion engine. In practice, turning motions of the combustion engine is transmitted via either the inner or the outer input shaft to the input gearwheels, to the output gearwheels, to the output shaft, and to one or wheels of a vehicle.

The application provides a powertrain and a vehicle with the power train. The powertrain is used for transmitting mechanical power to one or more wheels of the vehicle. The powertrain includes an internal combustion engine and the above-mentioned Dual Clutch Transmission. The Dual Clutch Transmission is engageable or is connectable to the internal combustion engine. The vehicle includes the powertrain and one or more wheels that are selectively connected to the powertrain.

### BRIEF DESCRIPTION OF THE DRAWINGS

The present invention will hereinafter be described in conjunction with the following drawing figures, wherein like numerals denote like elements, and.

FIG. 1 illustrates a three-dimensional cross-sectional view of an embodiment of a clutch actuation device;

FIG. 2 illustrates a two-dimensional view cross-sectional of the clutch actuation device of FIG. 1;

FIG. 3 illustrates a schematic view of a hydraulic system for operating the clutch actuation device of FIG. 1 and FIG. 2;

FIG. 4 illustrates a front view of a clutch casing of the clutch actuation device of FIG. 1;

FIG. 5 illustrates a perspective view of the clutch actuation device of FIG. 4;

FIG. 6 illustrates a transparent view of another embodiment of a clutch actuation device;

FIG. 7 illustrates a perspective view of the clutch actuation device of FIG. 6;

FIG. 8 illustrates a sectional view of the clutch actuation device of FIG. 6;

FIG. 9 illustrates a first oil supply path of the clutch actuation device of FIG. 6;

FIG. 10 illustrates a second oil supply path of the clutch actuation device of FIG. 6;

FIG. 11 illustrates an exposed view of oil passages of the clutch actuation device of FIG. 6; and

FIG. 12 illustrates a transparent view of the clutch actuation device of FIG. 6.

### DETAILED DESCRIPTION

The following detailed description is merely exemplary in nature and is not intended to limit application and uses. Furthermore, there is no intention to be bound by any theory presented in the preceding background of the invention or the following detailed description.

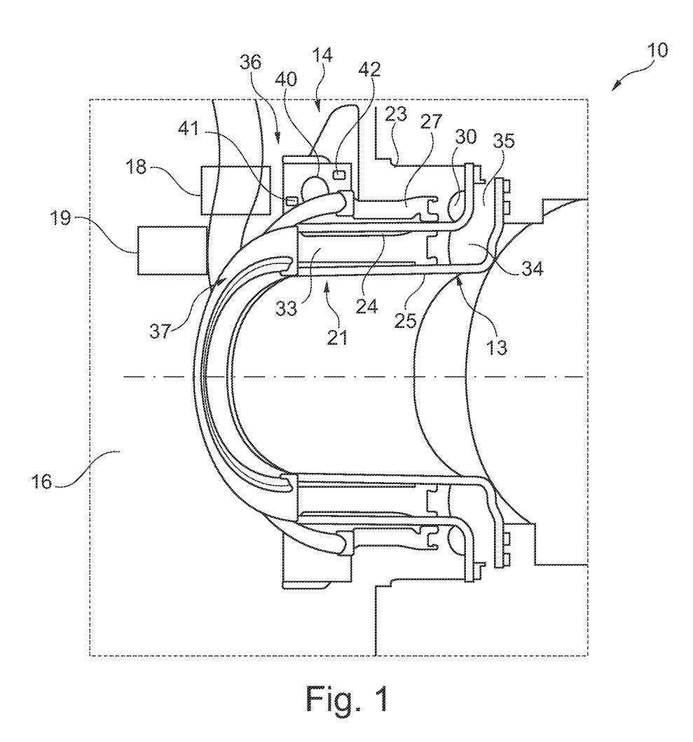

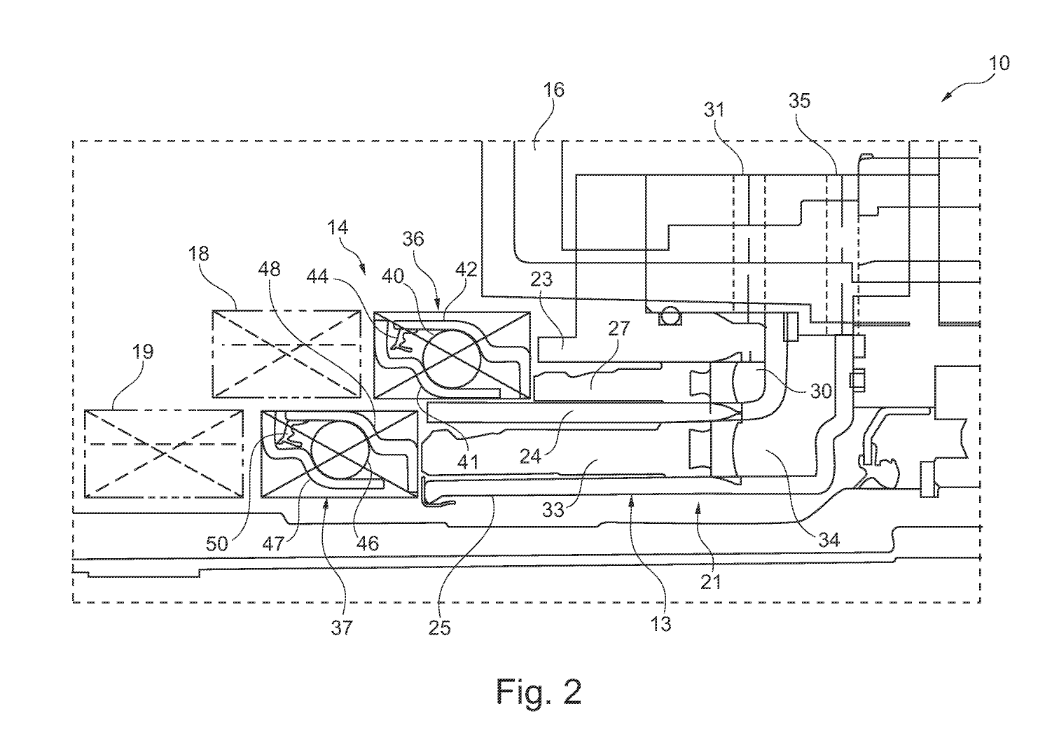

FIG. 1 and FIG. 2 depict cross-sectional views of a device 10 for actuating dual clutches of a Dual Clutch Transmission. The dual clutches allow a turning force from a combustion engine to be sent to a powertrain or to wheels of a vehicle. The Dual Clutch Transmission has gears that comprise wheels with teeth around outer edges of the wheels for controlling mechanical power from the combustion engine to the powertrain or to the wheels of the vehicle. The vehicle provides a means of transport.

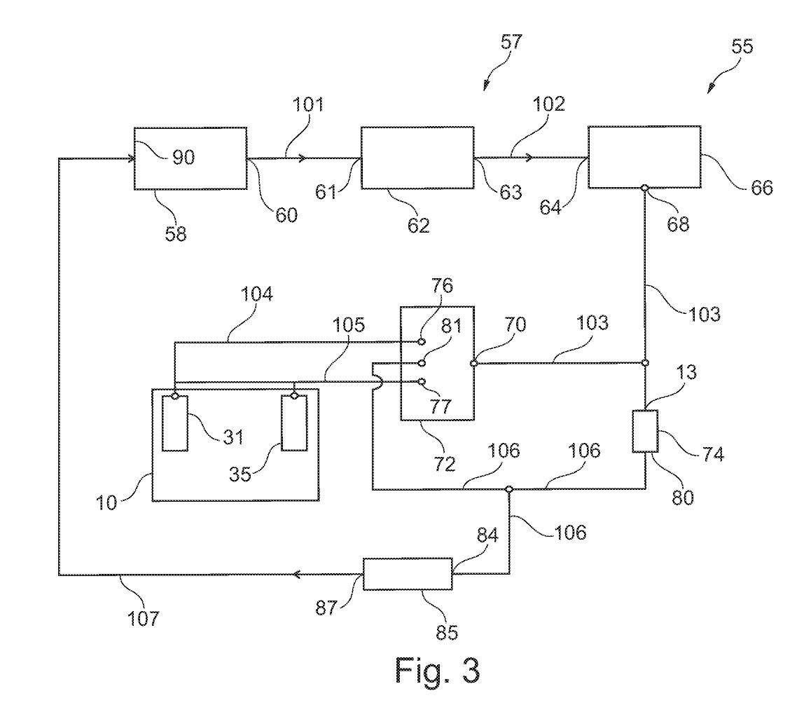

A control member 57, as shown in FIG. 3, actuates the clutch actuation device 10 for engaging or for acting on a first clutch release device 18 and a second clutch release device 19. The term “acting” is also called “bearing”. In particular, the drive member 14 is adapted to operate on clutch release devices 18 and 19, when the maneuvering member 13 acts or urges on the drive member 14 in the axial direction. The maneuvering member 13 is adapted for engaging or for acting by the control member 57.

The clutch actuation device 10 comprises a maneuvering member 13 and a drive member 14. The maneuvering member 13 is placed towards a gearbox side of the vehicle whilst the drive member 14 is placed towards a motor or a clutch side of the vehicle. The gearbox is also known as transmission casing. The motor is also known as combustion engine.

Referring to the maneuvering member 13, the maneuvering member 13 comprises a concentric slave cylinders assembly 21 with a set of pistons. The concentric slave cylinders assembly 21 is fixed or is secured to a clutch casing 16 or housing of the dual clutches. The clutch casing 16 encloses inner parts of the dual clutches and the concentric slave cylinders assembly 21. The concentric arrangement of the slave cylinders assembly 21 allows the clutch actuation device 10 to be implemented with less space as compared to other implementation arrangement or design.

The slave cylinders assembly 21 includes a first cylinder 23, a second cylinder 24, and a third cylinder 25. These cylinders 23, 24, and 25 share a same axis. The first cylinder 23 surrounds the second cylinder 24 as well as the third cylinder 25 whilst the second cylinder 24 surrounds the third cylinder 25. An outer annular piston 27 is disposed slidably between the first cylinder 23 and the second cylinder 24. The outer annular piston 27 has a first end and a second end. The first end is directed towards the gearbox side whilst the second end is directed towards the clutches side.

The first end of the outer annular piston 27 together with the first cylinder 23 and the second cylinder 24 form an outer annular chamber 30. The outer annular chamber 30 has an outer inlet 31. The first end of the outer annular piston 27 also forms essentially a hermetic seal with the first cylinder 23 and with the second cylinder 24 such that any liquid in the outer annular chamber 30 does not leak towards the second end of the outer annular piston 27. In a special embodiment, the hermetic seal is achieved by providing the first end of the outer annular piston 27 with a rubber seal. Further, the second end of the annular piston 27 is adapted for engaging or for acting on the drive member 14. Similarly, an inner annular piston 33 is disposed slidably between the second cylinder 24 and the third cylinder 25. The inner annular piston 33 has a first end and a second end. The first end is directed towards the gearbox side whilst the second end is directed towards the clutches side.

The first end of the inner annular piston 33 together the second cylinder 24 and the third cylinder 25 form an inner annular chamber 34. The inner annular chamber 34 has an inner inlet 35. The first end of the inner annular piston 33 also forms essentially a hermetic seal with the second cylinder 24 and with the third cylinder 25 such that any liquid in the inner annular chamber 34 does not leak to the second end of the inner annular piston 33. In an alternative embodiment, the hermetic seal is achieved by placing a rubber seal on the inner annular piston 33. Moreover, the second end of the inner annular piston 33 is adapted for engaging or for acting on the drive member 14. Further, the outer annular piston 27 surrounds the inner annular piston 33 such that the outer annular piston 27 and the inner annular piston 33 share the same axis. Likewise, the outer annular chamber 30 surrounds the inner annular chamber 34 so that the outer annular chamber 30 and the inner annular chamber 34 share the same axis. In a generic sense, the inner annular piston 33 and the second annular chamber 24 functions as part of a hydraulic motor. The outer annular piston 27 and the outer annular chamber 30 also functions as part of a hydraulic motor.

Referring to the drive member 14, the drive member 14 includes a first clutch bearing 36 and a second clutch bearing 37. The clutch bearings 36 and 37 are also known as clutch release bearings. The first clutch bearing 36 includes a ball bearing 40 and two generally annular members. The annular members comprises an inside ring 41 and an outside ring 42 that together encloses the ball bearing 40. A deflector 44 is placed between one end of the inside ring 41 and one end of the outside ring 42. The outside ring 42 is adapted for engaging or for acting by the second end of the outer annular piston 27 of FIG. 2. The inside ring 41 is adapted to bear on the clutch release device 18, when the outside ring 42 is acted on by the outer annular piston 27.

In a similar manner, the second clutch bearing 37 comprises a ball bearing 46, an inside ring 47 and an outside ring 48. The inside ring 47 and the outside ring 48 surrounds the ball bearing 46. A deflector 50 is positioned between one end of the inside ring 47 and one end of the outside ring 48. The outside ring 48 is adapted for engaging or for acting by the second end of the inner annular piston 33 of FIG. 2. The inside ring 47 is adapted to bear on the clutch release device 19, when the outside ring 48 is acted on by the inner annular piston 33. Moreover, the ball bearings 40 and 46 each comprises a ball cage, which is not shown, for retaining or keeping the ball bearings 40 and 46 in position. Lubricating grease is employed on the ball bearings 40 and 46 to ensure its anti-friction characteristic.

FIG. 3 shows a schematic view of a hydraulic system 55 for operating the clutch actuation device 10 of FIG. 1 and FIG. 2. The hydraulic system 55 does not include levers. The hydraulic system 55 includes a control member 57. The control member 57 includes a gear pump 66 for controlling or for actuating the clutch actuation device 10 using an operating valve 72 and a relief valve 74. Specifically, the control member 57 comprises a sump 58. The sump 58 is disposed in a lower portion of a transmission casing or housing. A first conduit 101 connects a sump outlet 60 to a filter inlet 61 whilst a second conduit 102 connects a filter outlet 63 to an inlet 64 of the gear pump 66. A third conduit 103 connects a gear pump outlet 68 to an inlet 70 of the operating valve 72 and to an inlet 73 of the relief valve 74.

A fourth conduit 104 connects a first operating valve outlet 76 to the outer inlet 31 of the outer annular chamber 30 whilst a fifth conduit 105 connects a second operating valve outlet 77 to the inner inlet 35 of the inner annular chamber 34 of the slave cylinders assembly 21. A sixth conduit 106 connects a relief valve outlet 80 to an operating valve inlet 81 and to an inlet 84 of a cooler 85. A seventh conduit 107 connects a cooler outlet 87 to a sump inlet 90.

In practice, the sump 58 contains or holds a working liquid, which usually is in the form of lubricating oil. The working liquid provides a medium for transmitting clutch actuation pressure to the clutch actuation device 10. The outer inlet 31 of the outer annular chamber 30 and the inner inlet 35 of the inner annular chamber 34 of the clutch actuation device 10 of FIG. 1 and FIG. 2 receive the clutch actuation pressure.

The lubricating oil is drawn from the sump 58 through the filter 62 by the gear pump 66 and it is forced under pressure through the relief valve 74 and through the operating valve 72 to the clutch actuation device 10. The filter 62 removes contaminants or foreign particles from the working liquid to keep these contaminants from reaching the relief valve 74 and the operating value 72.

The relief valve 74 is arranged or configured such that the relief valve 74 allows a relatively low pressure, for example, about five pounds per square inch, to be applied or transmitted to the clutch actuation device 10. This insures that the annular chambers 30 and 34 are filled constantly with the lubricating oil. The constant filling compensates for any leakage and allows for a rapid increase in the pressure of the lubrication oil in either outer annular chamber 30 or inner annular chamber 34 upon movement or activation of pressure by the operating valve 72.

When the Dual Clutch Transmission is in a neutral state, the operating valve 72 is also arranged to be in a neutral state. The neutral state is also called a neutral position. In the neutral state, the operating valve 72 does not transmit a pressure to the clutch actuation device 10. In this state, the clutches of the Dual Clutch Transmission are not engaged. In a case of a vehicle that has the Dual Clutch Transmission, a combustion engine of the vehicle is not connected to powertrain or to wheels of the vehicle, since the clutches are not engaged.

If a forward or a reverse gear of the Dual Clutch Transmission is selected, the pressure from the operating valve 72 is increased to actuate the appropriate clutch that corresponds to the selected gear. The selected gear relates to a particular gear ratio of the Dual Clutch Transmission. One gear would correspond to only one clutch of the dual clutches of the Dual Clutch Transmission. In most implementation, the forward gear of an odd number relates to one clutch of the dual clutches whilst the forward gear of an even number relates to the other clutch of the dual clutches.

The actuation of the clutch is achieved by transmitting the actuating clutch pressure from the gear pump 66, to the appropriate outlet 76 or 77 of the operating valve 72 via the lubricating oil. The actuating clutch pressure is also transmitted to the corresponding annular chamber 30 or 34. The corresponding annular chamber 30 or 34 experiences an increased rapidly pressure to the actuating clutch pressure of, for example, about one hundred pounds per square inch, while pressure of the other non-selected annular chamber 30 or 34 remains the low pressure of about five pounds per square inch.

The clutch actuation pressure is then exerted on the corresponding annular piston 27 or 33. This pressure actuates or moves the corresponding annular piston 27 or 33 to bear on the corresponding clutch bearing 36 or 37, and thus on the corresponding clutch release device 18 or 19 for engaging the appropriate selected clutch. If the clutch actuation pressure is removed or is reduced from the annular chamber 30 or 34, the corresponding clutch of the dual clutches is also released. Lubricating oil that does not reach the clutch actuation device 10 is passed through the cooler 85 en route to the sump 58, thus completing the cycle.

In a generic sense, the embodiment can include a coupling means to provide an appropriate axial linkage between the drive member 14 and the maneuvering member 13. Moreover, the outer annular piston 27 can comprise a transverse flange, which may be a simple collar, for engaging or for bearing on the first clutch bearing 36. The first clutch bearing 36 can comprise a radial rim and an axially acting annular spring. The axially acting annular spring is intended for engaging or for bearing on the radial rim to urge the radial rim towards the transverse flange of outer annular piston 27 in an axial direction. In this manner, the first clutch bearing 36 is retained axially or is secured relative to the outer annular piston 27.

Similarly, the inner annular piston 33 can comprise a transverse flange for engaging or for bearing on the second clutch bearing 37. The second clutch bearing 37 can also include a radial rim and an axially acting annular spring. The axially acting annular spring is intended for engaging or for bearing on the radial rim to urge the radial rim towards the transverse flange of inner annular piston 33 in an axial direction. In this way, the second clutch bearing 37 is retained axially relative to the inner annular piston 33.

In short words, the concentric slave cylinders assembly 21 actuates the two clutches of a Dual Clutch Transmission using a hydraulic system. The concentric slave cylinders assembly 21 is located in the clutch casing 16 as well as being fixed to the clutch casing 16. Each annular piston 27 or 33 of the slave cylinders assembly 21 applies or actuates the two clutches and release the two clutches through the application or release of bearings 36 and 37. Working liquid under adequate pressure is injected into the annular chambers 30 and 34 of the concentric slave cylinders assembly 21.

This embodiment operates the clutches in an innovative manner and requires less space in comparison with other piston actuation implementation. The embodiment also avoids usage of levers to actuate the clutches.

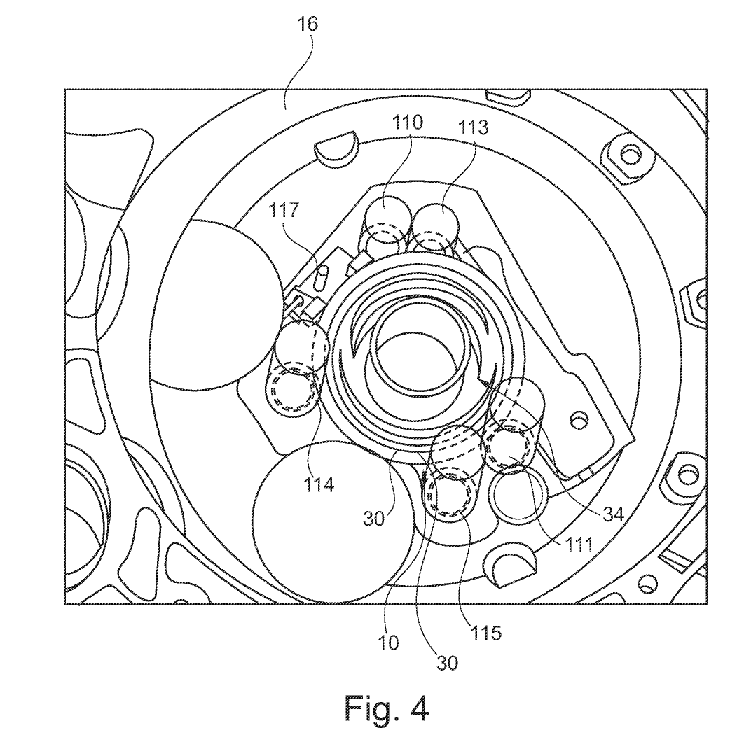

FIG. 4 depicts a front view of the clutch casing 16 of the clutch actuation device 10 of FIG. 1. The clutch casing 16 has attachment points 110 and 111, bearing plate points 113, 114, and 115, and a travel sensor 117. The attachment points 110 and 111, the bearing plate points 113, 114 and 115, together with the travel sensor 117 are placed next to the clutch actuation device 10. The clutch case clearance geometry is as indicated in the FIG. 4.

Functionally, the attachment points 110 and 111 are intended for the connected the clutch casing 16 to a gearbox casing of a transmission. The attachment points 110 and 111 have bolt openings or holes to secure the clutch casing 16 to the gearbox casing. The clutch-side bolt openings are formed at a lower side of the clutch casing 16 and are formed with internal threads to threadably engage setting bolts. The setting bolts can have screw-like metal objects that are used to fasten components together.

The bearing plate points 113, 114, and 115 are used for attaching a bearing retainer plate of the clutch casing 16 that is placed internally in the transmission. The bearing retainer plate is intended for supporting reaction loads form gears or gearwheels of the transmission. The travel sensor 117 is intended for indicating position of a clutch disc.

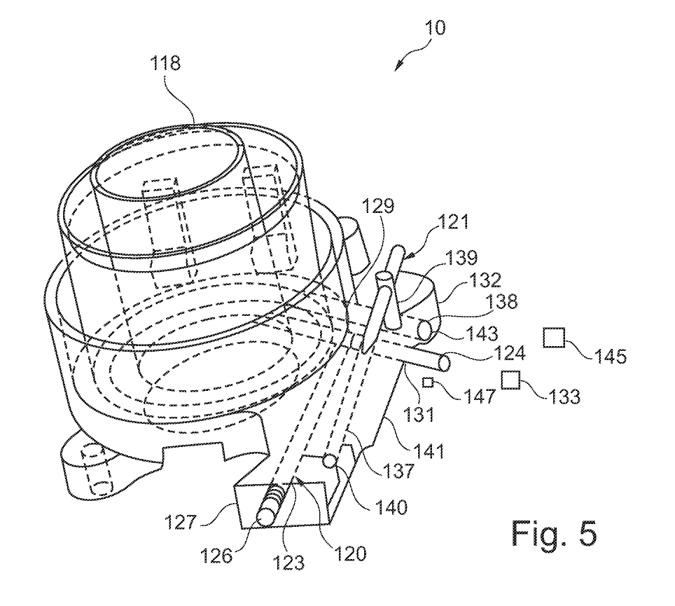

FIG. 5 shows a perspective view of a device casing 118 of the clutch actuation device 10 of FIG. 4. The device casing 118 encloses parts of the concentric slave cylinders assembly 21 with a set of pistons of FIG. 1. The clutch actuation device 10 has a device casing or housing that comprises a first passageway and a second passageway. The first passageway provides a working liquid to the inner annular chamber 34 whilst the second passageway provides a working liquid to the outer annular chamber 30 such that both passageways do not intersect with each other even though both passageways may be placed adjacent to each other.

Within the device casing 118 of the clutch actuation device 10 is formed an inner liquid supply passage 120 and an outer liquid supply passage 121. The inner liquid supply passage 120 is used to provide a working liquid to the inner annular chamber 34 whilst the outer liquid supply passage 121 is used to provide a working liquid to the outer annular chamber 30. The inner liquid supply passage 120 does not intersect with the outer liquid supply passage 121 even though the inner liquid supply passage 120 is provided adjacent to the outer liquid supply passage 121. A portion of the outer liquid supply passage 121 has an incline relative to the inner liquid supply passage 120 for avoiding the said intersection.

The inner liquid supply passage 120 comprises a first inner supply channel 123 and a second inner supply channel 124, which are extending essentially in a linear manner and are provided essentially in a same plane. The first inner supply channel 123 and the second inner supply channel 124 have an essentially longish or straight profile. One end of the first inner supply channel 123 is connected to a central portion of the second inner supply channel 124 so that a liquid in the first inner supply channel 123 can flow into the second inner supply channel 124.

The first inner supply channel 123 has a first end and a second end. The first end is placed at a front opening 126 at a front 127 of the device casing 118 of the clutch actuation device 10 whilst the second end is provided at an internal part 129 of the device casing 118 of the clutch actuation device 10. In contrast, the second inner supply channel 124 has a first end and a second end, wherein the first end is positioned at a first side opening 131 at a side 132 of the device casing 118 of the clutch actuation device 10 and the second end is provided at the inner inlet 35 of the inner annular chamber 34. A first channel seal 133 later covers the first side opening 131. A central portion of the second inner supply channel 124 is joined to the second end of the first inner supply channel 123 so that a liquid in the second inner supply channel 124 can flow into the first inner supply channel 123.

The outer liquid supply passage 121 comprises a first outer supply channel 137, a second outer supply channel 138 and a connecting outer channel 139 that connects the first outer supply channel 137 to the second outer supply channel 138. The connection allows a liquid in the first outer supply channel 137 to flow to the second outer supply channel 138 via the connecting outer channel 139. The first outer supply channel 137, the second outer supply channel 138 and the connecting outer channel 139 extend essentially in a linear manner. The first outer supply channel 137, the second outer supply channel 138 and the connecting outer channel 139 have an essentially longish or straight profile. In addition, the first outer supply channel 137 has a first end and a second end. The first end is placed at a bottom opening 140 at a bottom 141 of the device casing 118 of the clutch activation device 10 whilst the second end is provided at an internal part of the device casing 118 of the clutch actuation device 10.

In contrast, the second outer supply channel 138 has a first end and a second end, wherein the first end is positioned at a second side opening 143 at the side 132 of the device casing 118 of the clutch actuation device 10 and the second end is provided at the outer inlet 31 of the outer annular chamber 30. During operations, a second channel seal 145 later covers the second side opening 143.

The second end of the first outer supply channel 137 is joined to a first end of the connecting outer channel 139 whilst a central portion of the second outer supply channel 138 is joined to a second end portion of the connecting outer channel 139. The second end portion of the connection outer channel 139 is also connected an opening at the bottom of the device casing 118 of the clutch activation device 10. The opening is closed or is blocked by a channel seal 147. The arrangement allows a liquid in the first outer supply channel 137 to flow to the second outer supply channel 138 via the connecting outer channel 139.

Comparing the inner liquid supply passage 120 to the outer liquid supply passage 121, the first inner supply channel 123 is provided adjacent to the first outer supply channel 137. Moreover, the first inner supply channel 123 is not parallel to the first outer supply channel 137 and is at an incline relative to the first outer supply channel 137. The second inner supply channel 124 is placed adjacent to the second outer supply channel 138. The second inner supply channel 124 and the second outer supply channel 138 are positioned essentially in a same plane.

In one embodiment, the first inner supply channel 123 and the second inner supply channel 124 of the inner liquid supply passage 120 are formed by machining or by drilling. Then one end of the second inner supply channel 124 is blocked with the first channel seal 133. The drilling provides the essentially longish profile. Similarly, the first outer supply channel 137, the second outer supply channel 138 and the connecting outer channel 139 of the outer liquid supply passage 121 are formed by drilling. The second channel seal 145 afterward blocks one end of the second outer supply channel 138.

The above-mentioned incline advantageously enables the first inner supply channel 123 and the second inner supply channel 124 not to intersect with the first outer supply channel 137 and not to intersect with the second outer supply channel 138. Without the incline or positioning of the supply channels 124 and 137 at different levels, the said intersection would occur and thus preventing the clutch actuation device 10 from working properly.

Functionally, the first inner supply channel 123 and the second inner supply channel 124 provide a passageway for a working liquid to the inner annular chamber 34. The front opening 126 enables the working liquid to be introduced to the inner annular chamber 34. The first channel seal 133 blocks first side opening 131 such that the working liquid does not leak or flow out of the device casing 118 of the clutch actuation device 10.

Similarly, the first outer supply channel 137, the second outer supply channel 138 and the connecting outer channel 139 provide a passageway for a working liquid to the outer annular chamber 30. The bottom opening 140 allows the working liquid to be introduced to the first outer supply channel 137. The second channel seal 145 blocks the second side opening 143 such that the working liquid does not leak or flow out of the device casing 118 of the clutch actuation device 10. In a similar manner, the channel seal 147 blocks one end of the connecting outer channel 139 so that the working liquid does not leak or flow out of the device casing 118 of the clutch actuation device 10.

In a similar manner, the second opening of the first outer supply channel is used for introducing the working liquid that is pressured by the pump 66 to the outer chamber via the second end of the first outer supply channel and via the second end of the second outer supply channel. The channel seal blocks the first end of the second outer supply channel so that the working liquid does flow out of the device casing 118.

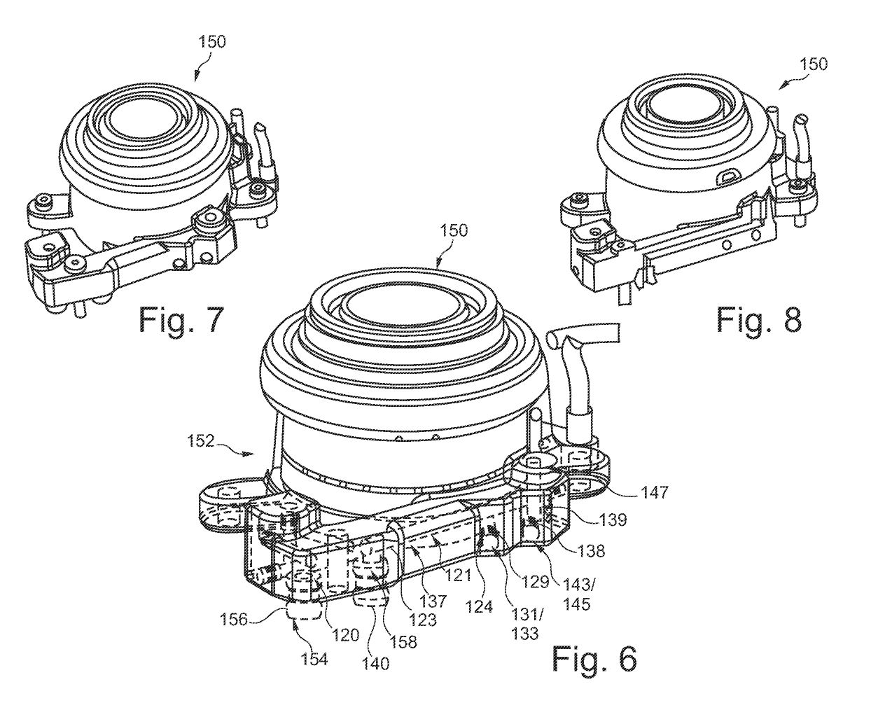

FIG. 6 shows a transparent view of another embodiment of a clutch actuation device 150. The FIG. 6 shows a way of providing oil passageways to the clutch actuation device 150. For better illustration of the embodiment, FIG. 7 shows a solid perspective view of the clutch actuation device 150. Similarly, FIG. 8 shows a sectional view of the clutch actuation device 150.

The clutch actuation device 150 and the clutch actuation device 10 of FIG. 1 have similar parts. The similar parts have similar names or same part numbers. The description of the similar parts is hereby incorporated by reference. FIG. 6 shows a device casing 152 of the clutch actuation device 150. The device casing 152 encloses parts of a concentric slave cylinders assembly.

Internally within the device casing 152, is formed the inner liquid supply passage 120 and the outer liquid supply passage 121. The inner liquid supply passage 120 does not intersect with the outer liquid supply passage 121 even though the inner liquid supply passage 120 is provided adjacent to the outer liquid supply passage 121. The inner liquid supply passage 120 is intended for introducing a working liquid to the inner annular chamber 34 whilst the outer liquid supply passage 121 is intended for introducing a working liquid to the outer annular chamber 30.

Further, the outer liquid supply passage 121 and the inner liquid supply passage 120 are positioned at different levels or heights. The difference in levels advantageously allows the liquid supply passages 120 and 121 to be adjacent to each other but yet without intersecting each other. An intersection of the said liquid supply passages 120 and 121 would prevent the clutch actuation device 150 from operating properly.

Structurally, the parts of the inner liquid supply passage 120 and the outer liquid supply passage 121 are described above, wherein the both supply passages 120 and 121, as provided here, are essentially parallel to each other. In addition, the inner liquid supply passage 120 is connected to a bottom opening 154 of the device casing 152 via a vertical connection channel 156. The working liquid is fed to the inner liquid supply passage 120 via the bottom opening 154 to the vertical connection channel 156. Similarly, the outer liquid supply passage 121 is connected to the bottom opening 140 of the device casing 152 a vertical connection channel 158. The working liquid is fed to the outer liquid supply passage 121 via the bottom opening 140 to the vertical connection channel 158.

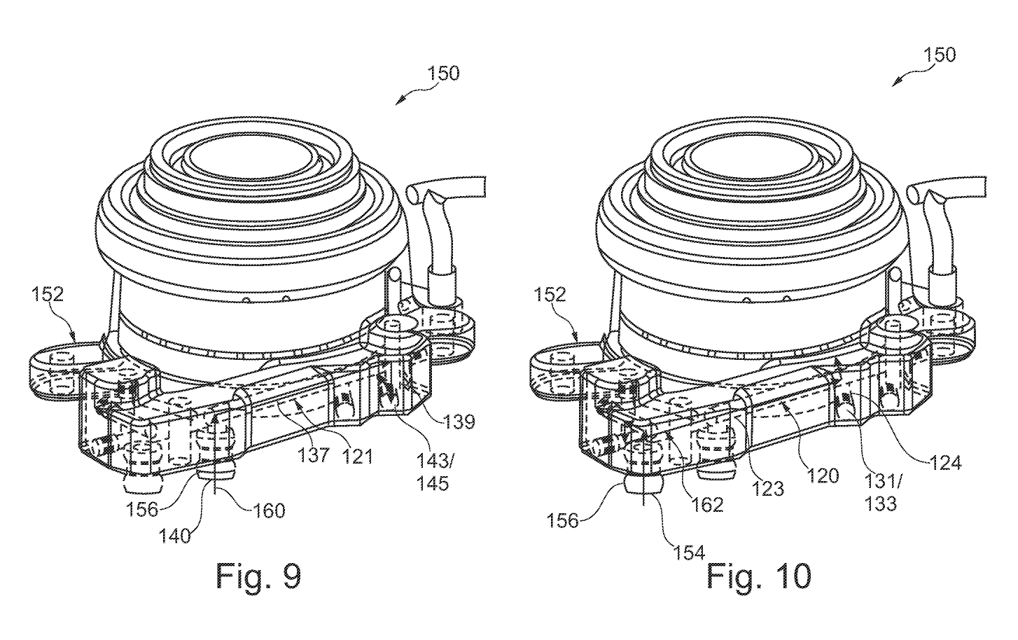

FIG. 9 shows a first oil supply path or route 160 of the clutch actuation device 150 of FIG. 6. The oil supply path 160 provides a passageway for feeding or introducing the working liquid to the outer annular chamber 30. The oil supply path 160 extends from the bottom opening 140, via the vertical connection channel 156, via the first outer supply channel 137, via the connecting outer channel 139, and via the second outer supply channel 138 to the outer annular chamber 30.

In a similar manner, FIG. 10 shows a second oil supply path 162 of the clutch actuation device 150 of FIG. 6. The oil supply path 162 provides a way for feeding or introducing the work liquid to the inner annular chamber 34. The oil supply path 162 extends from the bottom opening 154, via the vertical connection channel 156, via the first inner supply channel 123, and via the second inner supply channel 124 to the inner annular chamber 34.

Comparing FIG. 9 and FIG. 10, the first oil supply path 160 is positioned above the oil supply path 162. In addition, the oil supply path 160 is not at an incline or at an angle relative to the oil supply path 162. Put differently, the oil supply paths 160 and 162 are provided at different levels or heights, wherein the oil supply paths 160 and 162 are essentially parallel to each other. This difference of level allows the oil supply paths 160 and 162 not to intersect each other even though they are placed near each other.

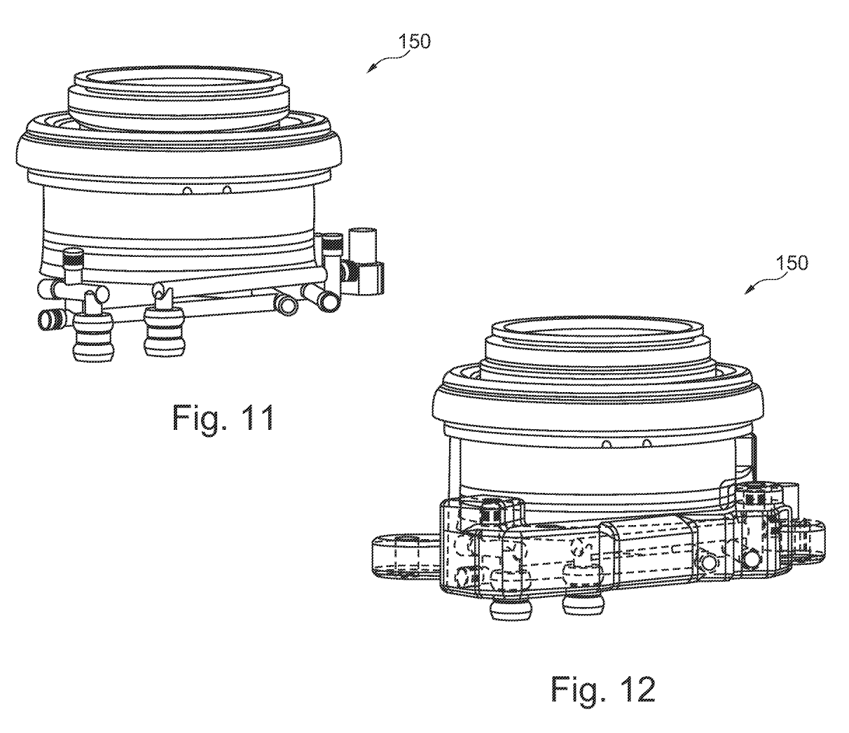

For easier illustration of the embodiments, FIG. 11 shows an exposed view of the oil passages of the clutch actuation device 150 of FIG. 6. FIG. 12 shows a transparent or an outline view of the clutch actuation device 150 of FIG. 6.

Although the above description contains much specificity, these should not be construed as limiting the scope of the embodiments but merely providing illustration of the foreseeable embodiments. Especially the above stated advantages of the embodiments should not be construed as limiting the scope of the embodiments but merely to explain possible achievements if the described embodiments are put into practice. Moreover, while at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A casing for a dual clutch actuation device of a transmission, the dual clutch actuation device comprising concentric slave cylinders that comprises an inner chamber for receiving liquid under pressure for actuating a first clutch disc and an outer chamber for receiving liquid under pressure for actuating a second clutch disc, the outer chamber surrounds at least a portion of the inner chamber, the casing comprising:
an internal inner liquid supply passage adapted to connect to the inner chamber, the internal inner liquid supply passage comprising a first inner straight section and a second inner straight section, the second inner straight section adapted to connect to the inner chamber; and
an internal outer liquid supply passage adapted to connect to the outer chamber, the internal outer liquid supply passage comprising a first outer straight section and a second outer straight section, the second outer straight section adapted to connect to the outer chamber.

2. The casing according to claim 1, wherein the internal inner liquid supply passage is essentially adjacent to the internal outer liquid supply passage.

3. The casing according to claim 1, wherein the internal inner liquid supply passage is at a first level and the internal outer liquid supply passage is at a second level that is different then the first level.

4. The casing according to claim 1, wherein the first inner straight section is at an incline relative to the first outer straight section.

5. The casing according to claim 1, wherein the second inner straight section and the second outer straight section are substantially perpendicular to an axis of the concentric slave cylinders.

6. The casing according to claim 5, wherein one end of the second inner straight section is blocked by a section seal.

7. The casing according to claim 1, wherein the first inner straight section is substantially perpendicular to the second inner straight section.

8. The casing according to claim 1, wherein the first outer straight section is connected to the second outer straight section via a connecting straight section.

9. The casing according to claim 8, wherein one end of the connecting straight section is blocked by a section seal.

10. The casing according to claim 8, wherein the first outer straight section is substantially perpendicular to the connecting straight section.

11. A clutch actuation device for dual clutches of a Dual Clutch Transmission, the clutch actuation device comprising:
a cylinder assembly fixed to a casing, the casing comprising:
an internal inner liquid supply passage;
an internal outer liquid supply passage; and
the cylinder assembly comprises:
an inner chamber adapted to receive liquid under pressure via the internal inner liquid supply passage;
an outer chamber adapted to receive liquid under pressure via the internal outer liquid supply passage, at least a portion of the inner chamber surrounded by the outer chamber;
an inner piston slidably disposed in the inner chamber for actuating a first clutch disc; and
an outer piston slidably disposed in the outer chamber for actuating a second clutch disc.

12. The clutch actuation device according to claim 11, further comprising:
a liquid source;
a pump adapted to supply liquid under pressure to the outer chamber and to the inner chamber; and
an operating valve adapted to control pressure of liquid to selectively engage one of the outer piston and the inner piston and to release of the other piston.

13. A clutch actuation device for a Dual Clutch Transmission comprising:
a cylinder assembly comprising:
a first hydraulic motor for actuating a first clutch of the Dual Clutch Transmission;
a second hydraulic motor for actuating a second clutch of the Dual Clutch Transmission,
wherein the first hydraulic motor and the second hydraulic motor are arranged such that at least a part of the first hydraulic motor is enclosed by the second hydraulic motor and
a casing fixed to the cylinder assembly, the casing comprising:
an internal inner liquid supply passage; and
an internal outer liquid supply passage,

14. The clutch actuation device according to claim 13, wherein the first hydraulic motor comprises:
an inner liquid chamber; and
an inner piston disposed in the inner liquid chamber; and
the second hydraulic motor comprises:
an outer liquid chamber; and
an outer piston disposed in the outer liquid chamber,
wherein at least the part of an inner chamber is enclosed by an outer chamber.

15. A dual clutch Transmission comprising
a first clutch disc being connected to an inner input shaft and an input gearwheel being provided on the inner input shaft,
a second clutch disc being connected to an outer input shaft and the input gearwheel being provided on the outer input shaft, the inner input shaft and the outer input shaft are arranged such that at least a portion of the inner input shaft being surrounded by the outer input shaft, and
a clutch actuation device adapted to selectively actuate the first clutch disc and the second clutch disc to engage a combustion engine, the clutch actuation device comprising:
a cylinder assembly fixed to a casing, the casing comprising:
an internal inner liquid supply passage;
an internal outer liquid supply passage; and
the cylinder assembly comprises:
an inner chamber adapted to receive liquid under pressure via the internal inner liquid supply passage;
an outer chamber adapted to receive liquid under pressure via the internal outer liquid supply passage, at least the portion of the inner chamber surrounded by the outer chamber;
an inner piston slidably disposed in the inner chamber for actuating the first clutch disc; and
an outer piston slidably disposed in the outer chamber for actuating the second clutch disc.

16. The clutch actuation device according to claim 15, further comprising:
a liquid source;
a pump adapted to supply liquid under pressure to the outer chamber and to the inner chamber; and
an operating valve adapted to control pressure of liquid to selectively engage one of the outer piston and the inner piston and to release of the other piston.
